(19) United States
(12) Patent Application Publication
(10) Pub. No.: US 2008/0094856 A1
(43) Pub. Date: Apr. 24, 2008

(54) Reversible lamp

(76) Inventors: Ceferino Garcia, Juarez (MX); Richard C. Laird, El Paso, TX (US)

Correspondence Address: OSRAM SYLVANIA INC, 100 ENDICOTT STREET, DANVERS, MA, 01923, US

(21) Appl. No.: 11/583,444

(22) Filed: Oct. 19, 2006

(51) Int. Cl. H01R 33/00

(52) U.S. Cl. 362/640

(57) ABSTRACT

A lamp (160) comprising: a light-emitting lamp capsule (161) arrayed about a longitudinal axis (161a); a base (162) supporting said lamp capsule (161), said base (162) including a peripheral flange (163) extending normal to said longitudinal axis 161a); and electrical contacts (164) attached to said peripheral flange for providing power to said light-emitting lamp capsule (161), said electrical contacts (164) extending from said peripheral flange (163) in a direction parallel to said longitudinal axis (161a).

### TECHNICAL FIELD

This invention relates to lamps sand more particularly to lamps that can load from a front or rear loading position.

### BACKGROUND ART

Lamp fixture manufacturers design fixtures for high power lamps to accept lamps from either a front or rear position. Such designs require a number of different lamps and a number of different sockets. Naturally, this requires manufacturers to keep an inventory of multiple lamps and sockets; an expensive and cumbersome approach to fixture design. It would, therefore, be an advance in the art if a lamp having multiple configurations could be provided that could load from either a forward loading or rear loading fixture.

### DISCLOSURE OF INVENTION

It is, therefore, an object of the invention to obviate the disadvantages of the prior art.

It is another object of the invention to enhance lamp sockets.

Yet another object of the invention is the provision of a lamp socket that can accept multiple lamps from a variety of positions.

These object are accomplished, in one aspect of the invention, by a lamp comprising: a light-emitting lamp capsule arrayed about a longitudinal axis; a base 162 supporting said lamp capsule, said base including a peripheral flange extending normal to said longitudinal axis, and electrical contacts attached to said peripheral flange for providing power to said light-emitting lamp capsule, said electrical contacts extending from said peripheral flange in a direction parallel to said longitudinal axis.

### BRIEF DESCRIPTION OF THE DRAWINGS

FIG. 1 is a diagrammatic view of a front-loading fixture;

FIG. 2 is a diagrammatic view of a rear-loading fixture; and

FIGS. 3-5 are perspective views of lamps illustrating embodiments of the invention;

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

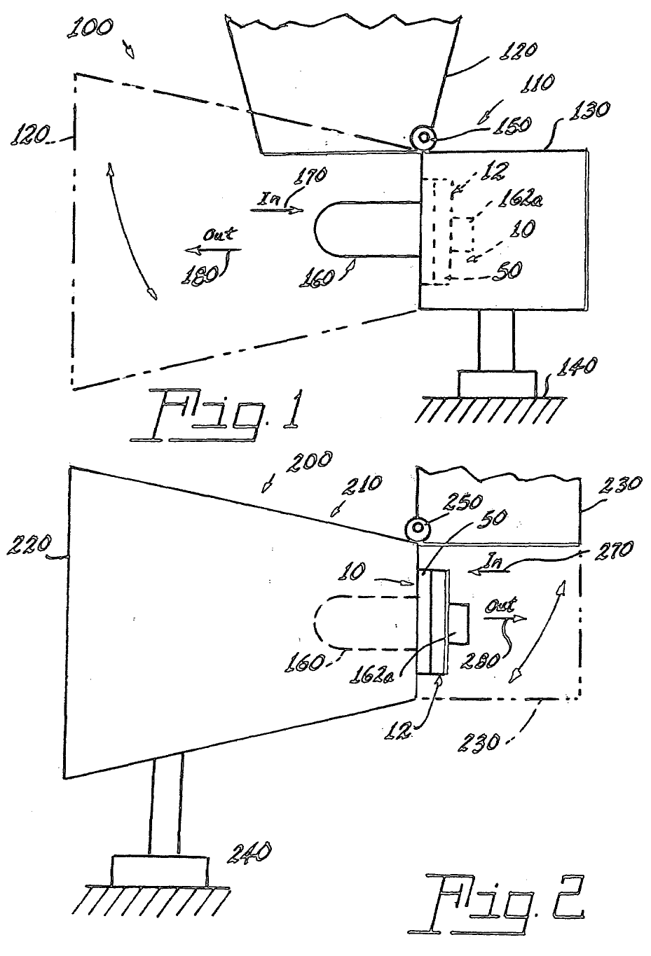

Referring now to the drawings with greater particularity, there is shown in FIG. 1 a front-loading fixture 100 having a housing 110 that includes a front portion 120 and a rear portion 130. The rear portion 130 can be fixed to a support 140 and the front portion 120 can be opened via a hinge 150 to gain access to a lamp 160 that is inserted into a socket 10. The lamp 160 is inserted and removed from the socket 10 in the directions indicated by the arrows 170, 180.

A rear-loading fixture 200 is depicted in FIG. 2 wherein the fixture 200 has a housing 210 with a front portion 220 and a rear portion 230. In this instance it is the front portion 220 that is fixed to a support 240 and the rear portion 230 that can be opened via a hinge 250 to gain access to a lamp 160 that is inserted into socket 10. The lamp 160 for fixture 200 is inserted and removed from the rear as indicated by the arrows 270, 280.

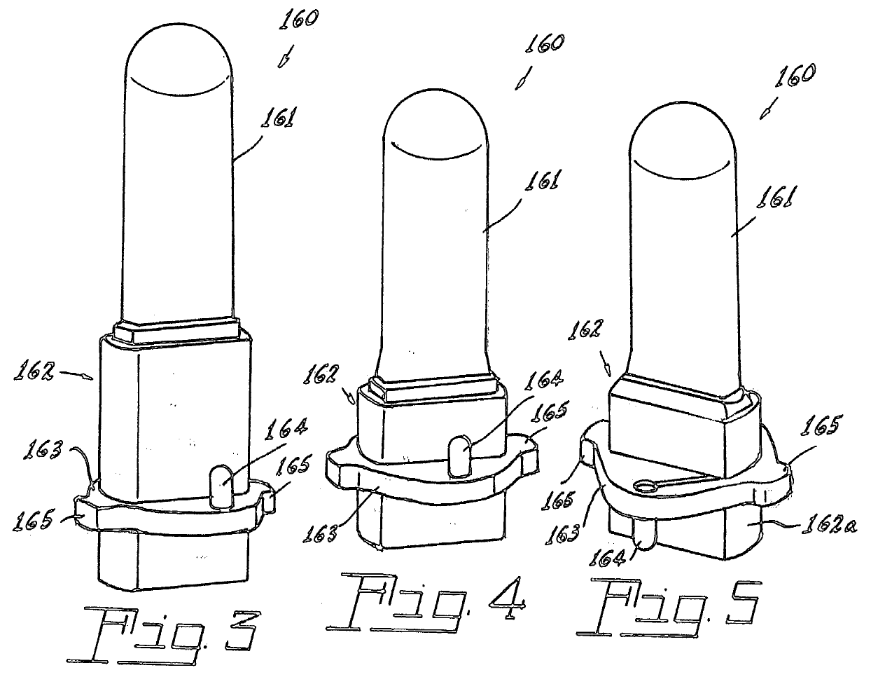

Referring to FIGS. 3-5, lamps 160 capable of accomplishing this desirable result comprise a lamp capsule 161 having a reversible base 162 of a suitable material, such as a high temperature ceramic or plastic. The base 162 includes a flange 163 with a pair of lamp contacts 164 oppositely disposed thereon and projecting therefrom. Lamp retainers 165 are formed with the flange 163 and are orthogonal to the lamp contacts 164. The bases 162 can have a long body, as is shown in FIG. 3 or a short body, as shown in FIGS. 4 and 5 to accommodate various types of light-emitting lamp capsules 161 such as tungsten halogen capsules, arc discharge capsules or capsules containing other types of light emitters. The capsules can be of varying lengths to provide different focal points.

The lamps 160, shown in FIGS. 3 and 4, have the lamp contacts 164, in the form of cylindrical prongs 164a and 164b, facing forward, that is, towards the lamp capsule, and these lamps are used with fixtures 200, where the lamps are inserted from the rear of the fixture.

The lamp 160, shown in FIG. 5, has the lamp contacts 164 facing rearward, that is, away from the lamp capsule and these lamps are employed with fixtures 100, where the lamp would be inserted from the front of the fixture.

Electrical connection from the lamp lead-ins can be provided via trenches 170 set into the flange 163, one of which is illustrated in FIG. 5.

While there have been shown what are at present considered to be the preferred embodiments of the invention, it will be apparent to those skilled in the art that various changes and modifications can be made herein without departing from the scope of the invention as defined by the appended claims.

1. A lamp comprising:
a light-emitting lamp capsule 161 arrayed about a longitudinal axis;
a base supporting said lamp capsule, said base including a peripheral flange extending normal to said longitudinal axis; and
electrical contacts attached to said peripheral flange for providing power to said light-emitting lamp capsule, said electrical contacts extending from said peripheral flange in a direction parallel to said longitudinal axis.

2. The lamp of claim 1 wherein said peripheral flange has a forward surface facing said light-emitting lamp capsule and said electrical contacts are positioned on said forward surface and extend toward said light-emitting lamp capsule.

3. The lamp of claim 1 wherein said peripheral flange has a rear surface facing away from said light-emitting lamp capsule and said electrical contacts are positioned on said rear surface and extend away from said light-emitting lamp capsule.

4. The lamp of claims 1, 2, or 3 wherein said electrical contacts comprise cylindrical prongs.

5. The lamp of claim 1 wherein said peripheral flange includes lamp retainers.

6. The lamp of claim 5 wherein said lamp retainers are orthogonal to said lamp contacts.
